(19) United States
(12) Patent Application Publication
(10) Pub. No.: US 2021/0137127 A1
(43) Pub. Date: May 13, 2021

(54) CONFECTIONERY CAPABLE OF ASSUMING AN ORNAMENTAL SHAPE, AND APPARATUS AND METHOD FOR PREPARING THE SAME

(71) Applicant: HELLO DELICIOUS BRANDS, LLC, Northbrook, IL (US)

(72) Inventors: David Hughes, Flourtown, PA (US); Robert Mott, Wildwood, MO (US); Kirsten Leo, Hatboro, PA (US); Matt Fick, Norristown, PA (US)

(21) Appl. No.: 16/488,546

(22) PCT Filed: Feb. 21, 2018
(86) PCT No.: PCT/US2018/018891

§ 371 Date: Aug. 23, 2019

Related U.S. Application Data
(60) Provisional application No. 62/466,835, filed on Mar. 3, 2017.

(51) Int. Cl. A21D 2/18; A21D 8/04; A21D 2/36

(52) U.S. Cl. CPC A21D 2/18; A21D 2/362; A21D 8/045

(57) ABSTRACT

A formula, apparatus and method of manufacturing a confectionery with an ornamental shape is disclosed. The invention comprises a jacket dough capable of being formed into an ornamental shape, said jacket dough further comprising flour; a leavening system; an oil, water and emulsifier system; sweeteners; flavoring additives; and coloring additives.

### CROSS REFERENCE TO RELATED APPLICATIONS

This application is a National Phase Patent Application based on International Patent Application PCT/US18/018891, filed on Feb. 21, 2018, which claims priority to U.S. Provisional Patent Application No. 62/466, 835, filed on Mar. 3, 2017, the entire contents of both are hereby incorporated by reference.

### FIELD OF THE INVENTION

The invention relates generally to a formula, apparatus and method of manufacturing a confectionery with an ornamental shape, and snacks made therefrom. More specifically, the invention relates to a method of preparing a teardrop or fig-shaped confectionery utilizing a jacket dough and filler, as well as an apparatus for extruding a teardrop of fig-shaped confectionery utilizing said jacket dough and filler.

### BACKGROUND OF THE INVENTION

Innovation in the food industry is unceasing. The combination of flavors, textures, and forms among other organoleptic properties into new platforms for the consumer is a matter of never ending research and investigation. This is especially the case with snack foods. Still, even with investigation, it is not a certainty that the modification of one food stuff into a different food product will prove palatable. The production of a food stuff which proves palatable, nutritious, and is enticing to the consumer is artistry and not just a matter of routine research and development.

Snacks are generally divided into five broad groups: baked goods, salted snacks, specialty snacks, confectionery snacks, and naturally occurring snacks. Baked goods include, but are not limited to, cookies, crackers, sweet goods, snack cakes, pies, granola/snack bars, and confectioneries. Salted snacks include, but are not limited to, potato chips, corn chips, tortilla chips, extruded snacks, popcorn, pretzels, potato crisps, and nuts. Specialty snacks include, but are not limited to, dips, dried/fruit snacks, meat snacks, pork rinds, health food bars such as Power Bars® and rice/corn cakes. Confectionery snacks include various forms of candy. Naturally occurring snack foods include nuts, dried fruits and vegetables. Traditional snacks cut across the five groups as they comprise select species of snacks, including, but not limited to, cookies, brownies, filled crackers, snack cakes, pies, potato crisps, corn ships, tortilla chips, filled extruded snacks, enrobed extruded snacks, pretzels, spreads or dips, rice/corn cakes, and confectionery snacks.

Numerous obstacles and technical challenges may arise to preclude the delivery of desirable snacks and mixes to the consumer. One example which illustrates the complexity of food processing is the production of filled confectioneries which assume a distinctive ornamental shape. Filled confectioneries typically comprise a filler such as a jelly, jam, paste, cream or custard, and are enclosed by a baked jacket dough. The fillers are typically liquid to semi-solid in form and therefore cannot maintain a defined shape. As such the jacket dough provides most, if not all of the structure of the confectionery. The baked jacket dough must therefore impart sufficient structure to allow for a shelf stable product, yet at the same time have organoleptic properties which are pleasing to the consumer. Examples of jacket dough and filler confectioneries include U.S. Pat. Nos. 8,980,355; 7,163,710; 4,020,188 and 2,272,989.

Confectioneries are often manufactured in shapes that are visually pleasing to the consumer and/or mimic the shape of the foods the confectionery seeks to emulate. For example, the shape of filled confectioneries have been manufactured for decades, yet to date no fig-filled confectionery has been manufactured that mimics the shape of a fig, which is analogous to a teardrop shape. It is believed that the difficulty in producing a fig or teardrop shaped filled confectionery is due to the jacket dough being unable to maintain a fig or teardrop shape from the time the confectionery is baked through packaging and eventual consumption by the consumer. Prior attempts to create a fig or teardrop shaped product have failed, as the baked jacket dough of the finished product collapsed during packaging or subsequent storage. What is needed is a jacket dough that contains the organoleptic properties of a confectionery, yet has the structural integrity to assume an ornamental shape.

### SUMMARY OF THE INVENTION

The invention relates generally to a formula, apparatus and method of manufacturing a confectionery with an ornamental shape, and snacks made therefrom. More specifically, the invention relates to a formula, apparatus and method for fig or teardrop shaped confectioneries. It has been discovered that the formulation of a raw jacket dough that is approximately 15 wt % water and approximately 20 wt % tapioca syrup produces a final baked product that can both accept a filler and has the organoleptic properties of a confectionery, yet has the structural integrity to assume ornamental shapes. Moreover, it has been discovered that the co-extrusion of a confectionery at approximately 295 g/m to 630 g/m, via a novel nozzle in combination with a novel utter—such that the confectionery is cut in approximately 6.0-9.0 g increments—results in a filled confectionery with an ornamental fig or teardrop shape, and can maintain its shape up to consumption.

### BRIEF DESCRIPTION OF THE FIGURES

FIG. 1 is a top-down view of a representative co-extruder and ban oven system for production of the fig-shaped food product, in accordance with the present disclosure;

FIG. 2 is a side view of a representative co-extruder and ban oven system for production of the fig-shaped food product, in accordance with the present disclosure;

FIG. 3 is a upward view of a representative manifold of a co-extruder for production of the fig-shaped food product, in accordance with the present disclosure;

FIG. 4 is a front view of a representative co-extruder for production of the fig-shaped food product, in accordance with the present disclosure;

FIG. 5 contains multiple perspective view of a representative outer nozzle for use with the co-extruder used in the production of the fig-shaped food product, in accordance with the present disclosure;

FIG. 6 contains multiple perspective view of a representative inner nozzle for use with the co-extruder used in the production of the fig-shaped food product, in accordance with the present disclosure;

FIG. 7 contains multiple perspective view of a representative cutter for use with the encruster used in the production of the fig-shaped food product, in accordance with the present disclosure;

FIG. 8 is a block diagram depicting a method of producing the fig-shaped product, in accordance with the present disclosure;

FIG. 9 is a bottom plan view of a confectionery product in accordance with the present disclosure;

FIG. 10 is a side plan view of a confectionery product in accordance with the present disclosure;

FIG. 11 is an opposite view of FIG. 2 of a confectionery product in accordance with the present disclosure;

FIG. 12 is an bottom elevation view of a confectionery product in accordance with the present disclosure;

FIG. 13 is a top elevation view of a confectionery product in accordance with the present disclosure;

FIG. 14 is an front elevation view of a confectionery product in accordance with the present disclosure;

FIG. 15 is a rear view of a confectionery product in accordance with the present disclosure; and

FIG. 16 is a section side elevation view of a confectionery product in accordance with the present disclosure.

### DETAILED DESCRIPTION

The invention comprises a food confectionery with an outer baked jacket dough, which in turn encloses a filler. The invention further comprises a method of preparing a teardrop or fig-shaped confectionery utilizing said jacket dough and filler, as well as an apparatus for extruding a teardrop of fig-shaped confectionery utilizing said jacket dough and filler.

The jacket dough comprises a flour, a leavening system, a sweetener, flavoring and coloring, as well as an oil, water and emulsifier system. The compositions of the filler vary and are in accordance with known fillers in the art such as jams, jellies, pastes, creams, custards and the like.

The jacket dough of the invention may incorporate any number of flours useful in providing a dough of appropriate consistency. The flour material can be derived from various grain materials including, but not limited to, wheat flour such as durum, semolina and the like. It is also possible to employ other types of flour material into the dough and snack of the invention. Non-limiting examples include material derived from other cereals and grains including, but not limited to, maize, corn, rice, barley, etc.

Wheat flour is a powder made from the grinding of wheat used for human consumption. More wheat flour is produced than any other flour. Wheat varieties are called “soft” or “weak” if gluten content is low, and are called “hard” or “strong” if they have high gluten content. Hard flour, or bread flour, is high in gluten, with 12% to 14% gluten content. Its dough has elastic toughness that holds its shape well once baked. Soft flour is comparatively low in gluten and thus results in a loaf with a finer, crumbly texture.

In terms of the parts of the grain (the grass fruit) used in flour—the endosperm or protein/starchy part, the germ or protein/fat/vitamin-rich part, and the bran or fiber part—there are also three general types of flour. White flour is made from the endosperm only. Brown flour includes some of the grain's germ and bran, while whole grain or whole meal flour is made from the entire grain, including the bran, endosperm, and germ. Germ flour is made from the endosperm and germ, excluding the bran.

Preferably, the various compositions of the jacket dough of the invention comprise whole wheat flour.

### Leavening System

The jacket dough of the present invention comprises a leavening system. Leavening systems useful in this invention generally comprise adding a chemical leavening agent to the jacket dough prior to baking. Chemical leavening agents are mixtures or compounds that release gases when they react with each other, with moisture, or with heat. Most are based on a combination of acid and a salt of bicarbonate. Chemical leaveners are used in quick breads and cakes, as well as cookies and numerous other applications where a long biological fermentation is impractical or undesirable. Chemical leavening agents include, but are not limited to baking powder, baking soda, sodium bicarbonate, monocalcium phosphate, sodium aluminum sulfate, disodium phosphate, and sodium aluminum phosphate. Preferably, the various compositions of the jacket dough of the invention comprise a leavening system of sodium bicarbonate and monocalcium phosphate.

### Oil, Emulsifier and Water System

The jacket dough of the present invention also comprises an oil, emulsifier and water system. The oil is used as a substitute for shortening and includes but is not limited to any commercially available vegetable and animal oils including canola oil, olive oil, corn oil, soybean oil, peanut oil, sunflower oil, etc. The oil adds flavor as well as well as aids in creating a tender or flaky final product. Preferably the oil utilized in the various compositions of the jacket dough of the invention comprises canola oil.

The emulsifier stabilizes and prevents separation of ingredients in the dough, and reduces the rate of retrogradation (staling). In addition, the emulsifier serves as a dough conditioner by interacting with gluten to strengthen the protein network resulting in a desirable texture. Emulsifiers include but are not limited to egg yolk, lecithins including soy lecithin, genetically modified organism-free (GMO-free) soy lecithin, sodium and calcium stearoyl lactylate, monoglycerides and diglycerides, ethoxylated monoglycerides and diglycerides, polysorbates, succinylated monoglycerides, and diacetyl tartaric acid esters of monoglycerides, polysorbates, succinylated monoglycerides, and diacetyl tartaric acid esters of monoglycerides. Preferably, the emulsifier utilized in the various compositions of the jacket dough of the invention comprises GMO-free soy lecithin.

Finally, the addition of water provides moisture to the final product, ensuring desired organoleptic properties. The moisture provided the by water can also aid in the structural integrity of the finished product, ensuring that the product is not too dry or flaky such that it crumbles or otherwise loses its shape during packaging. It has been found that a raw dough having between 13-15 wt % water, preferably 14.74 wt % water, provides sufficient moisture to allow the jacket of the finished product of the invention to maintain a teardrop of fig like shape after baking and packaging, yet having pleasing organoleptic properties.

### Sweeteners

The jacket dough and food product of the invention also comprise a sweetener. Depending on the sweetener incorporated into the dough, the sweetener may add to organoleptic properties by providing added bulk or elasticity in the case of natural sugars (aside from the added taste of sweeteners) among other properties. Natural or synthetic (nutritive and nonnutritive) sweeteners may be used in the dough and food product of the invention.

Natural (or nutritive) sweeteners may include sugar as well as sugar salts and derivatives derived from fruits and vegetables including fructose, mannose, sucrose, corn syrup, including high fructose corn syrup, hydrogenated starch, hydrosylates, molasses, chocolate syrup, granular sugar, GMO-free granular sugar, vegetable syrups such as brown rice syrup, tapioca syrup iso malt, malt, maltose, maltilol, glycerol, and mixtures thereof, among others.

Other (nutritive and nonnutritive) sweeteners useful in the dough and food product of the invention may include aspartame, cyclamates, sucralose, stevioside, and saccharin, as well as curculin, erythritol, neotame and mixtures thereof, among others. Combinations of nutritive and nonnutritive sweeteners may also be used if there is a desire for sweetness with a lower calorie value.

Preferably, the various compositions of the jacket dough of the invention comprise GMO-free granular sugar. Additionally the various compositions of the jacket dough of the invention also comprise tapioca syrup. Tapioca syrup is a sweetener derived by culturing ground cassava root starch with saccharifying enzymes to break down the starches, producing a syrup. We have found that tapioca syrup, in addition to providing sweeteners, serves as an ideal binding agent. We have found that a dough comprising approximately 17.5-22.5 wt % tapioca syrup, preferably 20.06 wt %, in combination with the effective amounts of water referenced above, result in a jacket of the finished product of the invention which maintains a teardrop or fig like shape after baking and packaging, yet have pleasing organoleptic properties.

### Flavoring and Coloring Additives

The jacket dough and food product of the invention may also comprise various flavoring and coloring additives to modify the appearance of the final product as well as its organoleptic properties. One such additive is quick oats, which modify the flavor and texture of the baked jacket dough, as well as serve as a source of fiber. Effective amounts of salt may be added as well. Additionally, soy fiber may be added to the jacket dough to provide additional fiber content. The jacket dough may also comprise fruit or other flavor additives that mimic or compliment the flavors of the filler. Such flavorings include, but are not limited to, chocolate flavoring, strawberry flavoring, blueberry flavoring and fig flavoring. Additionally food dyes and other colorings may be added to the jacket dough to create a visually pleasing baked product. One preferred coloring is caramel coloring.

Illustrative concentrations for all ingredients are found in the TABLE 1 below:

TABLE 1
(wt-%)

| Dough Constituents | Useful | Preferred | More Preferred |
|---|---|---|---|
| Quick Oats | 5.0-15.0 | 7.5-12.5 | 9.0-10.0 |
| Salt | 0.1-1.0 | 0.25-0.75 | 0.4-0.5 |
| GMO-Free Granulated Sugar | 2.5-7.5 | 4.0-6.5 | 4.5-5.0 |
| GMO-Free Soy Lecithin | 0.05-0.25 | 0.1-0.225 | 0.175-0.20 |
| Tapioca Syrup | 15.0-25.0 | 17.5-22.5 | 20.0-21.0 |
| Water | 10.0-20.0 | 12.5-17.5 | 14.0-15.0 |
| Caramel Color | 0.1-0.5 | 0.2-0.4 | 0.3-0.35 |
| Fruit Flavoring | 0.1-0.6 | 0.15-0.55 | 0.4-0.5 |
| Canola Oil | 5.0-15.0 | 7.0-13.0 | 11.0-12.0 |
| Monocalcium Phosphate | 0.01-0.15 | 0.05-0.125 | 0.075-0.1 |
| Sodium Bicarbonate | 0.1-0.25 | 0.15-0.225 | 0.175-0.20 |
| Organic Soy Fiber | 0.1-0.25 | 0.15-0.225 | 0.175-0.20 |
| Whole Wheat Flour | 25.0-45.0 | 20.0-40.0 | 37.0-39.0 |

### Apparatus

With reference to FIGS. 1 and 2, a co-extruder 1 is disclosed. The general design of the extruder is consistent with other food co-extruders known in the art, such as the Rheon® Mutli Co-Extruder. At the top of co-extruder 1 are two hoppers 3 and 5. Hoppers 3 and 5 are designed to accept food ingredients to be processed in the extruder and feed the food ingredients to other sections of the extrusion apparatus for processing. The hoppers 3 and 5 may be any shape that promotes gravity feeding and, as such, may be rectangular, cylindrical, conical, a frustum, etc.

Hoppers 3 and 5 are in fluid communication with, and are situated directly above, housing 7. Hoppers 3 and 5 are in fluid communication with and augers 9 and 11 [not shown], respectively, which direct food ingredients to housing 7. Housing 7 receives the food ingredients and contains machinery to process the food ingredients. As such, housing 7 may be any shape which can accommodate both the machinery and the food ingredients.

Located within housing 7 are feed rollers 13 and 15 [not shown]. Feed rollers 13 and 15 are in fluid communication with hoppers 3 and 5 and augers 9 and 11. Feed rollers 13 and 15 are rotatably mounted within housing 7 by way of axles 17 and 19 [not shown], or by other means known in the art. Feed rollers 13 and 15 are actuated by a belt/chain drive 21 [not shown] or by other actuation means known in the art.

Feed rollers 13 and 15 are preferably cylindrical, however other geometries that can be rotatably mounted may also be utilized. The dimensions of feed rollers 13 and 15 can vary, and are consistent with feed rollers known in the art. Feed rollers 13 and 15 feed the ingredients to pumps 21 and 23 respectively, also contained within housing 7. Pumps 21 and 23 force the jacket dough and filler into manifold 25. Manifold 25 is depicted in FIGS. 2-4. As best shown in FIG. 3, manifold 25 contains both an outer nozzle or cup 27 which accepts the jacket dough, and an inner nozzle 29 which accepts the filler. Outer nozzle 27 is depicted in detail in FIG. 5. As FIG. 5 shows, the exterior 28 of outer nozzle 27 is cup-shaped, whereas the interior 30 of outer nozzle 27 is a frustum. Outer nozzle 27 has an extrusion orifice 32 which is 22 mm in diameter, an inlet 34 which is 56 mm in diameter, and a height 36 which is 49 mm. Inner nozzle 29 is funnel or frustum-shaped and has an extrusion orifice 38 which is 12 mm in diameter, an inlet 40 which is 25 mm in diameter, and a height 42 which is 82 mm. Inner nozzle 29 is designed to fit within the interior 30 of outer nozzle 27. As the jacket dough is poured into the outer nozzle 27, the jacket dough forms a central cavity into which the inner nozzle 29 deposits the filler, resulting in the co-extrusion of a combined jacket dough and filler extrusion 44, as shown in FIG. 4. FIG. 4 also shows that the co-extruder manifold 25 may have multiple outer nozzle 27/inner nozzle 29 combinations, allowing for the co-extrusion of multiple combined jacket dough and filler extrusions 44 in parallel.

After the combined jacket dough and filler extrusion 44 is extruded, it is fed to encruster (or cutter) 31. As shown in FIG. 3, encruster 31 includes teeth 33. As the combined jacket dough and filler extrusion 44 is extruded, teeth 33 enclose around the combined jacket dough and filler extrusion and sever the extrusion into individual products 46. Teeth 33 are depicted in detail in FIG. 7. Each of the individual teeth 33 has a length 48 of 30 mm, a width 50 of 15 mm and a height 52 of 33.6 mm. The design of encruster 31, in particular teeth 33, along with the shape of outer nozzle 27 and inner nozzle 29, are such that, when cut, the individual product 46 resembles a teardrop or fig shape, as shown in FIGS. 4, 9-16.

As shown in FIGS. 1, 2 and 4, in fluid communication with housing 7 is conveyor 35. Conveyor 35 receives the processed food product from housing 7 and transfers the food product away from the co-extruder 1 to band oven 37 for baking. After the food product is baked it is transferred by conveyor 35 for further processing and/or packaging. Conveyor 35 is actuated by means known in the art. Additionally, conveyor 35 may be linked to other conveyors for further processing and or analysis.

A controller 39, an embodiment of which is disclosed in FIGS. 1-2, is in communication with conveyor 35 and co-extruder 1. Controller 39 may take the form of a control box, computer, control pad or other control devices known in the art and may be either wired or wireless. Controller 39 controls the rotational speed of feed rollers 13 and 15, augers 9 and 11, pumps 21 and 23, and conveyor 35. Controller 35 may also control other features of co-extruder 1 consistent with conventional co-extruders known in the art.

### Method

Referring to FIG. 8, a method in accordance with the claimed invention is disclosed. Specifically, block 41 of FIG. 8 discloses the preparation of a mixture of quick oats, salt, sugar, soy lecithin, tapioca syrup, water, caramel coloring and flavoring, which is mixed with low agitation in a mixer for approximately 2 minutes. Once this is complete canola oil is added and the resulting mixture is mixed with low agitation in a mixer for another approximately 2 minutes, as shown in block 43 of FIG. 8. Finally, as block 45 of FIG. 8 shows, monocalcium phosphate, sodium bicarbonate, soy fiber and wheat flour are added and the resulting mixture is mixed with high agitation in a mixer for approximately 1 to 2 minutes, preferably 1 minute. Throughout the mixing process the dough is maintained at a temperature between 65° F.-75° F., preferably 70° F.

Next, as shown in block 47 of FIG. 8, a filler such as a jam, jelly, paste, cream or custard is prepared and mixed via methods known in the art. After mixing of the jacket dough and the filler are complete, the filler is fed into hopper 3 of co-extruder 1, while the jacket dough mixture is fed into hopper 5 of co-extruder 1, as shown in block 49 of FIG. 8. The filler and jacket dough are separately fed by auger 9 and auger 11, respectively, to feed rollers 13 and 15, respectively, and finally to mechanically driven pumps 21 and 23, respectively. Pumps 21 and 23 force the jacket dough and filler into manifold 25. As shown in step 51 of FIG. 8, manifold 25 co-extrudes a single product that contains the filler enclosed by the jacket dough. Augers 9 and 11, feed rollers 13 and 15 and pumps 21 and 23 are calibrated such that the combined jacket dough and filler extrusion 44 is extruded at a rate of approximately 395 g/m to 630 g/m per outer nozzle 27/inner nozzle 29 combination, and preferably 525 g/m per combination. The co-extruder may have multiple nozzle 27/inner nozzle 29 combinations, allowing for the co-extrusion of multiple combined jacket dough and filler extrusions 44 in parallel. Each combined jacket dough and filler extrusion 44 is preferably 38%-42% filler and 58%-62% jacket dough, and more preferably 40% filler and 60% jacket dough.

After the combined jacket dough and filler extrusion 44 is extruded from the nozzle, it is fed to encruster (or cutter) 31, as shown in step 53 of FIG. 8. The encruster 3 is calibrated such that it cuts the extruded combined jacket dough and filler product at approximately 66-70 cuts per minute, preferably 70 cuts per minute, resulting in a fig or teardrop shaped product that has a pre-bake mass between 6.0 grams and 9.0 grams, and preferably 7.5 grams.

After the combined jacket dough and filler product is cut, it is deposited on conveyor 35 and fed into band oven 37, as shown in steps 55 and 57 of FIG. 8. The band oven may have one or more heating zones, the one or more zones baking the combined jacket dough and filler product at a temperature of 345° F. for a time of approximately 11 minutes to 12 minutes, preferably 11 minutes and 12 seconds. After baking is complete the combined jacket dough and filler product is packaged, as shown in Step 59 of FIG. 8. The mass of the baked combined jacket dough and filler product, as well as the water and tapioca syrup content of the finished product, ensure that the finished combined jacket dough and filler product maintains it shape and consistency during the packaging process, up to consumption.

### WORKING EXAMPLES

The following examples provide a representative illustration of the invention.

### Example 1

A jacket dough is prepared according to the formulation set forth in TABLE 2:

TABLE 2
(wt-%)

| | |
|---|---|
| Quick Oats | 9.12 |
| Salt | 0.41 |
| GMO-Free Granular Sugar | 4.92 |
| GMO-free Soy Lecithin | 0.18 |
| Tapioca Syrup | 20.06 |
| Water | 14.74 |
| Caramel Color | 0.30 |
| Natural Strawberry Flavor | 0.45 |
| Canola Oil | 11.54 |
| Monocalcium Phosphate | 0.09 |
| Sodium Bicarbonate | 0.18 |
| Organic Soy Fiber | 0.18 |
| Whole Wheat Flour | 37.82 |

A mixture of the quick oats, salt, sugar, soy lecithin, tapioca syrup, water, caramel coloring and fruit flavoring is first prepared, and is mixed with low agitation in a mixer for approximately 2 minutes. Once this is complete the canola oil is added and the resulting mixture is mixed with low agitation in a mixer for another approximately 2 minutes. Finally the monocalcium phosphate, sodium bicarbonate, soy fiber and wheat flour are added and the resulting mixture is mixed with high agitation in a mixer for approximately 1 minute. Throughout the mixing process the dough is maintained at a temperature of 70° F.

Separately a filler is prepared according to the formulation set forth in TABLE 3:

TABLE 3
(wt-%)

| | |
|---|---|
| Organic Fig Paste | 38.68 |
| Organic Granular Sugar | 28.20 |
| Organic Corn Syrup | 15.84 |
| Organic Strawberry Chia Filling | 9.56 |
| Water | 4.35 |
| WIP Organic Ground Meal 40# | 2.28 |
| Salt | 0.64 |
| Natural Strawberry Flavor | 0.44 |

After mixing the jacket dough and the filler are complete, the filler is fed into hopper 3 of co-extruder 1, while the jacket dough mixture is fed into hopper 5 of co-extruder 1. The jacket dough and filler are separately fed by auger 9, which corresponds to hopper 3, and auger 11, which corresponds to hopper 5, to feed rollers 13 and 15, which in turn feed the jacket dough and filler into mechanically driven pumps 21 and 23. Pumps 21 and 23 force the jacket dough and filler into manifold 25. Manifold 25 contains both outer nozzle/cup 27, which accepts the jacket dough, and inner nozzle 29 which accepts the filler. As the jacket dough is poured into the outer nozzle 27, the jacket dough forms a central cavity into which the inner nozzle 29 deposits the filler, resulting in the co-extrusion of a combined jacket dough and filler extrusion 44. Augers 9 and 11, feed rollers 13 and 15 and pumps 21 and 23 are calibrated such that the combined jacket dough and filler extrusion 44 is extruded from each outer nozzle 27/inner nozzle 29 combination at a rate of approximately 525 g/m.

After the combined jacket dough and filler extrusion 44 is extruded form the nozzle, it is fed to encruster (or cutter) 31. The encruster 31 is calibrated such that it cuts the extruded combined jacket dough and filler extrusion 44 at 70 cuts per minute resulting in a product 46 that is fig or teardrop shaped and has a pre-bake mass of 7.5 grams.

After the product 46 is cut, it is deposited on conveyor 35 and fed into band oven 37. The band oven may have one or more heating zones, the one or more zones baking the product 46 at a temperature of 345° F. for a time of 11 minutes and 12 seconds. After baking is complete the baked product 46 is packaged.

Although the invention has been described by reference to its preferred embodiment as is disclosed in the specification and drawings above, many more embodiments of the invention are possible without departing from the invention. Thus, the scope of the invention should be limited only by the appended claims.

What is claimed is:

1. A composition comprising a jacket dough capable of being formed into an ornamental shape, said jacket dough further comprising:
flour;
a leavening system;
an oil, water and emulsifier system;
sweeteners;
flavoring additives; and
coloring additives.

2. The composition of claim 1, wherein said water comprises 14.74 wt % of the jacket dough.

3. The composition of claim 1, wherein:
said flour comprises whole wheat flour;
said leavening system comprises sodium bicarbonate and monocalcium phosphate;
said oil, water and emulsifier system comprises canola oil and GMO-free soy lecithin;
said sweeteners comprises GMO-free granular sugar and tapioca syrup;
said flavoring additives comprises salt, quick oats, fruit flavoring and organic soy fiber; and
said coloring additives comprises caramel coloring.

4. The composition of claim 3, wherein:
said whole wheat flour comprises approximately 30.0-40.0 wt % of the jacket dough;
said sodium bicarbonate comprises approximately 0.15=0.225 wt % of the jacket dough;
said monocalcium phosphate comprises approximately 0.05-0.125 wt % of the jacket dough;
said canola oil comprises approximately 7.0-13.0 wt % of the jacket dough;
said water comprises approximately 12.5-17.5 wt % of the jacket dough;
said GMO-free soy lecithin comprises approximately 0.1-0.225 wt % of the jacket dough;
said GMO-free granular sugar comprises approximately 4.0-6.5 wt % of the jacket dough;
said tapioca syrup comprises approximately 17.5-22.5% wt % of the jacket dough;
said salt comprises approximately 0.25-0.75 wt % of the jacket dough;
said quick oats comprises approximately 7.5-12.5 wt % of the jacket dough;
said fruit flavoring comprises approximately 0.15-0.55 wt % of the jacket dough;
said organic soy fiber comprises approximately 0.15-0.225 wt % of the jacket dough; and
said caramel coloring comprises approximately 0.2-0.4 wt % of the jacket dough.
